(19) United States
(12) Patent Application Publication
(10) Pub. No.: US 2013/0000041 A1
(43) Pub. Date: Jan. 3, 2013

(54) Occupant Support with a Cyclically Variable Profile

(76) Inventors: Timothy Joseph Receveur, Guilford, IN (US); Charles A. Lachenbruch, Lakeway, TX (US)

(21) Appl. No.: 13/173,521

(22) Filed: Jun. 30, 2011

(51) Int. Cl. A47C 27/10; A47C 27/08; A61G 7/002

(52) U.S. Cl. 5/618; 5/613; 5/706

(57) ABSTRACT

An occupant support (30) such as a hospital bed comprises a support structure (56), at least one component of which has a variable profile, an actuation system (100) for varying the profile, and a controller (150) responsive to prescribed profile cycle parameters for commanding the actuation system to effect a cyclic variation in the profile. A mattress (110) comprises a primary support (114) and an elevator (206) above the primary support. The elevator has a deflated state in which it cooperates with the primary support to provide popliteal support to a supine occupant of the mattress. The elevator also has an inflated state in which it withholds popliteal support. Another mattress (110) comprises individual bladders (114), some of which are cyclically inflatable and deflatable. When inflated, the bladders cooperate with the other bladders to provide popliteal support for a supine occupant. When deflated, the bladders cooperate with the other bladders to define an effective concavity that withholds popliteal support.

### TECHNICAL FIELD

The subject matter described herein relates to a variable profile occupant support and a controller responsive to user input for commanding an actuation system to execute one or more cycles of profile variation. One example embodiment of the occupant support is a hospital bed in which the cyclic profile variation can be used for passive flexion and extension of an occupant's knee joint.

### BACKGROUND

Individuals who have undergone knee surgery may be required to receive post-operative therapy on the affected knee joint, sometimes beginning only a few hours after surgery. Among such therapies or exercises are simple flexion and extension of the knee joint.

Many modern hospital beds feature adjustability of the bed profile or contour, which is defined by certain elements of the bed and is experienced by the bed occupant. For example FIG. 7 of U.S. Pat. No. 5,781,949 shows a bed whose deck segments describe a longitudinally undulating profile as seen in side elevation. A supine occupant of the bed as illustrated in FIG. 7 would experience a small amount of knee flexion. FIG. 8 shows the same bed with the deck segments defining a longitudinal profile similar to that of a chair. A supine occupant of the bed as illustrated in FIG. 8 would experience a larger amount of knee flexion. FIGS. 5 and 6 show that the bed can also be inclined in a head-down or foot-down orientation without affecting its side profile, i.e. without departing from the flat profile of FIGS. 1-2. Although FIGS. 7 and 8 of the patent shows configurations corresponding to knee flexion, the patent does not appear to describe any capability to cyclically vary the profile in response to a user input. The patent also does not appear to describe any adjustability of the lateral profile (the profile seen in end elevation) however FIGS. 18-20 show the use of pulmonary bladders to affect the lateral orientation of a foundation base so that the occupant can be placed in a left side up or a right side up lateral orientation.

It may be desirable for the patient's hospital bed to include features that enable the bed to apply a prescribed flexion/extension therapy in accordance with an initial caregiver input, but without further caregiver intervention.

### SUMMARY

An occupant support such as a hospital bed comprises a support structure, at least one component of which has a variable profile, an actuation system for varying the profile, and a controller responsive to prescribed profile cycle parameters for commanding the actuation system to effect a cyclic variation in the profile. A mattress comprises a primary support, and an elevator above the primary support. The elevator has a deflated state in which it cooperates with the primary support to provide popliteal support to a supine occupant of the mattress. The elevator also has an inflated state in which it withholds popliteal support. Another mattress comprises individual bladders, some of which are cyclically inflatable and deflatable. When inflated, the bladders cooperate with the other bladders to provide popliteal support for a supine occupant. When deflated, the bladders cooperate with the other bladders to define an effective concavity that withholds popliteal support.

### BRIEF DESCRIPTION OF THE DRAWINGS

The foregoing and other features of the various embodiments of the occupant support described herein will become more apparent from the following detailed description and the accompanying drawings in which:

FIG. 1 is a schematic side elevation view of an occupant support in the form of a hospital bed comprising an air mattress and a segmented deck with the deck segments oriented to define a flat profile or contour of the deck;

FIG. 2 is a view of the bed of FIG. 1 showing two deck segments having been re-oriented to define a non-flat profile or contour and showing a rotational re-orientation of a third segment in phantom;

FIG. 3 is a block diagram showing a variable profile bed support structure, a support structure actuation system, a user interface, a sensor for sensing an aspect of the variable profile, and a controller that receives user input from the interface prescribing a cyclic variation of a bed profile and for commanding the actuation system to effect the prescribed cyclic variation;

FIG. 4 is a graph illustrating a profile cycle, a portion of a subsequent cycle and identifying profile cycle parameters;

FIG. 5 is a view similar to that of FIG. 2 showing an embodiment with a translatable deck with the deck segments having been translated footwardly and oriented to define another non-flat profile;

FIG. 6 is a view similar to that of FIG. 5 showing an embodiment with a translatable deck with the deck segments having been further re-oriented to define yet another non-flat profile;

FIG. 7 is a side elevation view similar to that of FIG. 1 in which the deck is illustrated as being non-segmented and in which a bellows, shown in a deflated or collapsed state, resides above the air mattress;

FIG. 8 is a view of the bed of FIG. 5 showing the bellows in an inflated or expanded state;

FIG. 9 is a side elevation view similar to that of FIG. 7 but with a triplet of longitudinally distributed orientation adjustment bladders, shown in a deflated or collapsed state, residing above the air mattress;

FIG. 10 is a view of the bed of FIG. 9 showing the orientation adjustment bladders in an inflated or expanded state;

FIG. 11 is a view similar to that of FIG. 7 in which the mattress is a foam mattress, and in which a bellows, shown in a deflated or collapsed state, resides between the mattress and the deck;

FIG. 12 is a view of the bed of FIG. 11 showing the bellows in an inflated or expanded state;

FIG. 13 is a side elevation view similar to that of FIG. 11 but showing a hybrid configuration having a segmented deck with the deck segments oriented to define a flat profile and a bellows shown in a deflated or collapsed state.

FIG. 14 is a view of the bed of FIG. 13 showing the deck thigh and calf sections having been reoriented and showing the bellows in an inflated or expanded state to define a non-flat profile.

FIG. 15 is a schematic side elevation view of an occupant support in the form of a hospital bed comprising an air mattress and a non-segmented deck with the mattress inflated to define a flat profile or contour;

FIG. 16 is a view of the bed of FIG. 15 showing selected bladders having been deflated to withdraw popliteal support from a supine occupant of the bed thereby placing the occupant's knee joint in a state of extension;

FIG. 17 is a schematic side elevation view of an occupant support in the form of a hospital bed comprising a primary support structure in the form of an air mattress, a non-segmented deck, and an elevator in the form of a set of longitudinally distributed, selectively inflatable bladders residing above the primary support and shown in a deflated state;

FIG. 18 is a view of the bed of FIG. 17 showing to selected ones of the elevator bladders having been inflated;

FIG. 19 is a view of the bed of FIG. 18 showing selected others of the elevator bladders having been inflated;

FIG. 20 is a schematic side elevation view of an occupant support in the form of a hospital bed comprising a deck, a mattress and a spacer for enabling or withdrawing popliteal support to a supine occupant of the bed, the spacer being shown in a neutral position in which it enables popliteal support;

FIG. 21 is a view of the bed of FIG. 20 showing the spacer having been moved longitudinally and vertically to a position in which popliteal support is withheld.

### DETAILED DESCRIPTION

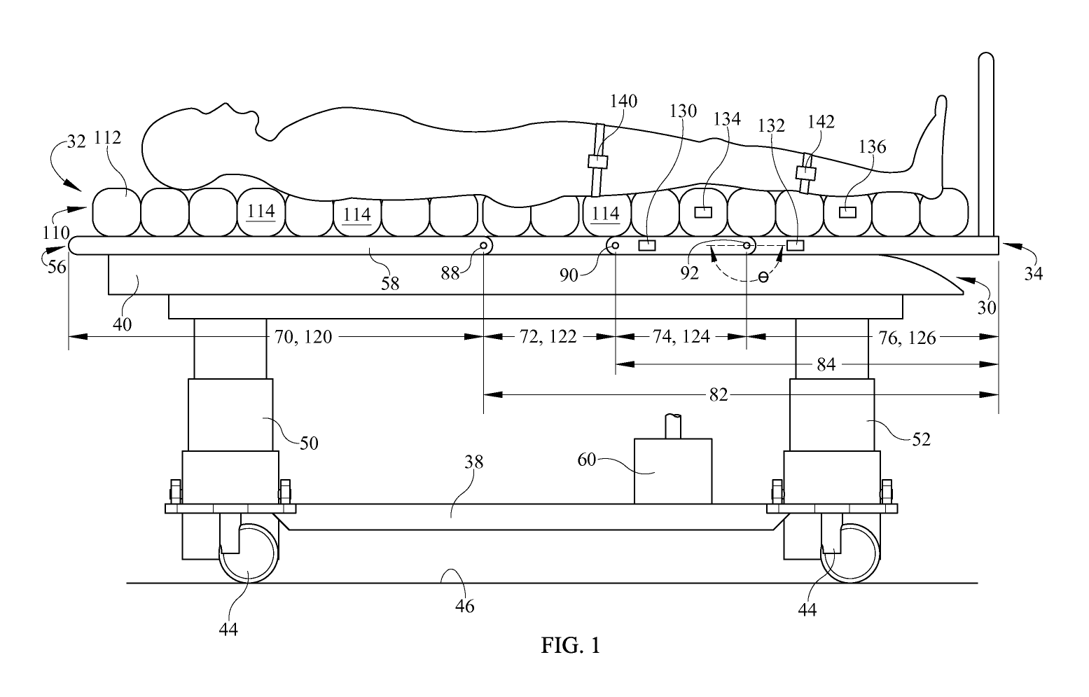

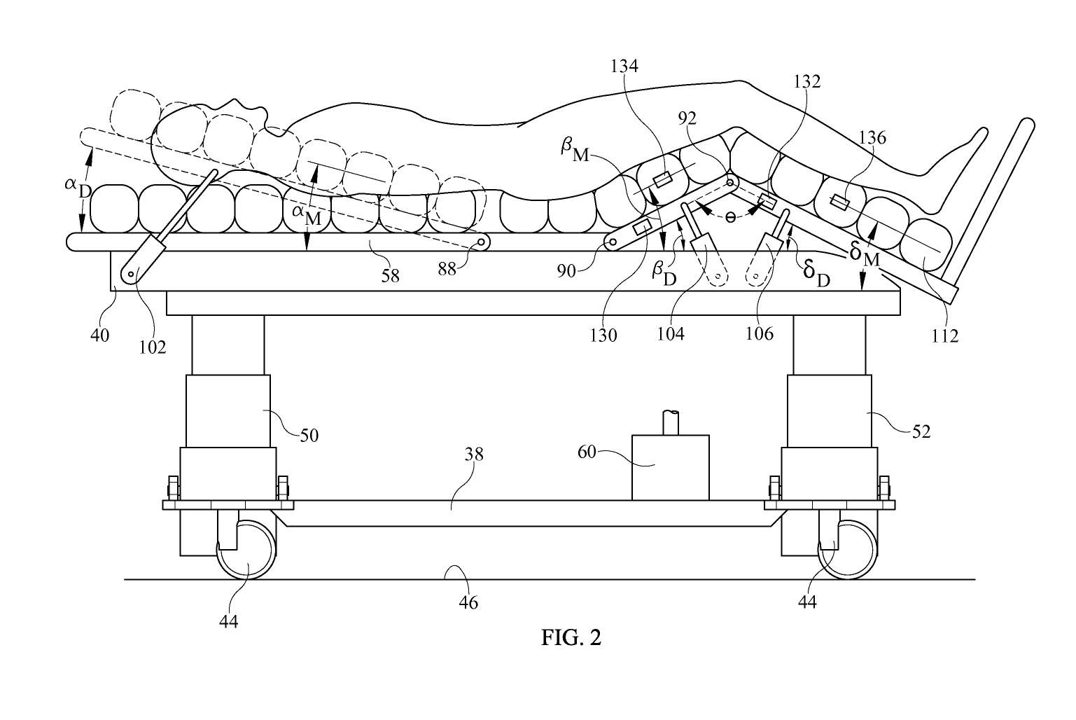

Referring to FIGS. 1-2 an occupant support 30 such as a hospital bed extends longitudinally from a head end 32 to a foot end 34 and laterally from a right side (seen in the plane of the illustration) to a left side. The bed includes a base frame 38 and an elevatable frame 40. Casters 44 extend from the base frame to floor 46. A lift system, represented by canister lifts 50, 52, extends between the base frame and elevatable frame and renders the elevatable frame height adjustable relative to the base frame. The bed also includes a support structure 56, for example a deck 58, supported by the elevatable frame. A pump 60 satisfies the demands of bed components that require pressurized air.

The illustrated deck is a four segment deck comprising an upper body or torso segment 70, a seat segment 72, a thigh segment 74, and a calf segment 76 corresponding approximately to an occupant's torso, buttocks, thighs, and calves respectively. The seat, thigh and calf segments comprise a lower body segment 82. The thigh and calf segments comprise a leg segment 84. The deck segments are rotatable about hinges or joints 88, 90, 92. As a result, the upper body, thigh and calf segments are orientation adjustable between a substantially 0° orientation relative to the elevatable frame (FIG. 1) and a less horizontal orientation as indicated by angles α_{D}, β_{D}, δ_{D} (FIG. 2). The angular orientations of the thigh and calf segments define an intersegment angle θ.

Some bed architectures employ a three segment deck. A three segment deck (not illustrated) is similar to a four segment deck but does not include a dedicated seat segment 72. In a three segment deck the thigh segment corresponds to the occupant's thighs and buttocks.

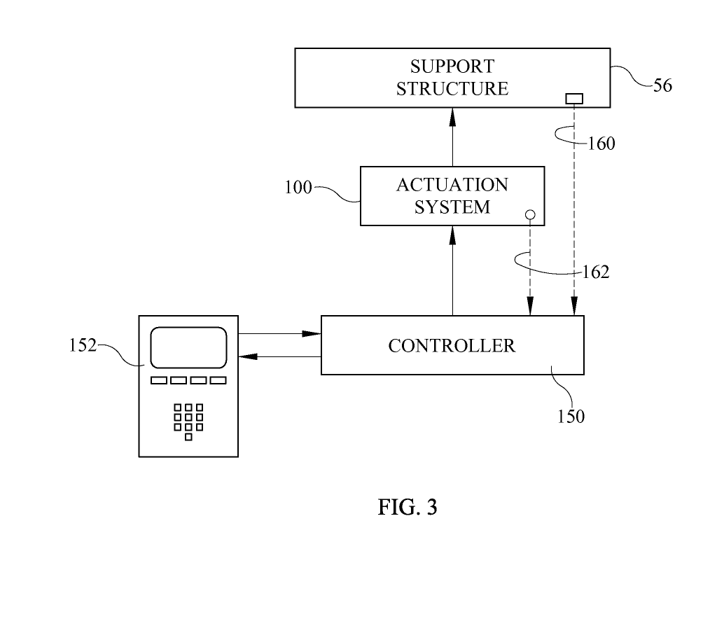

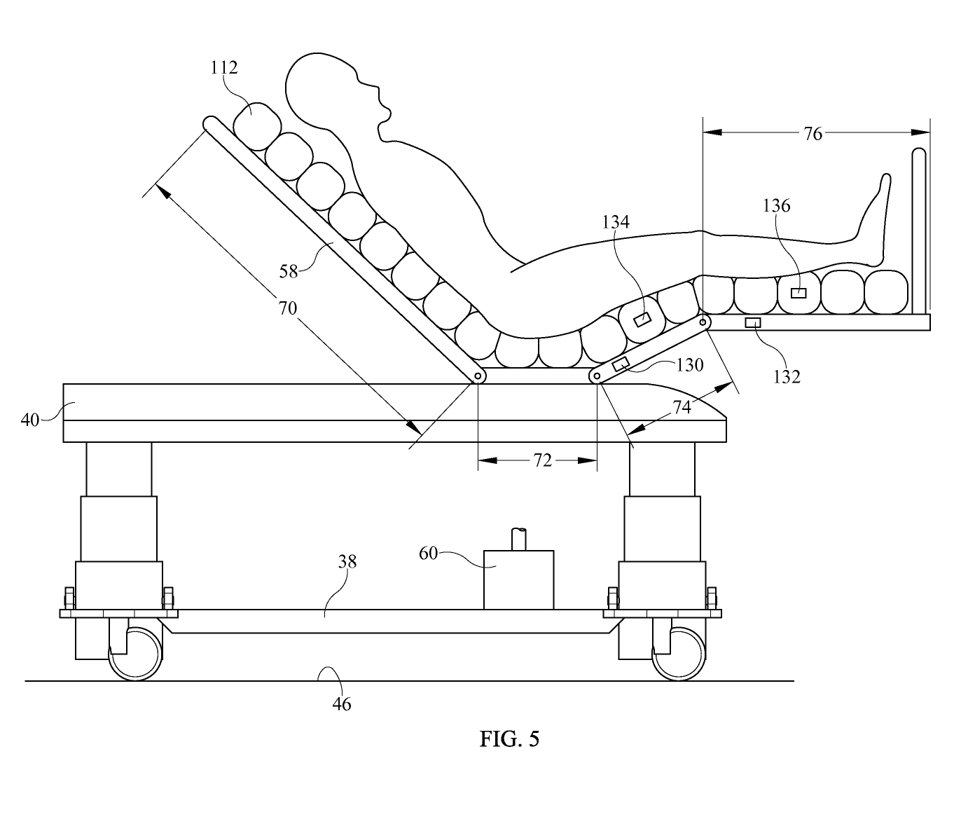

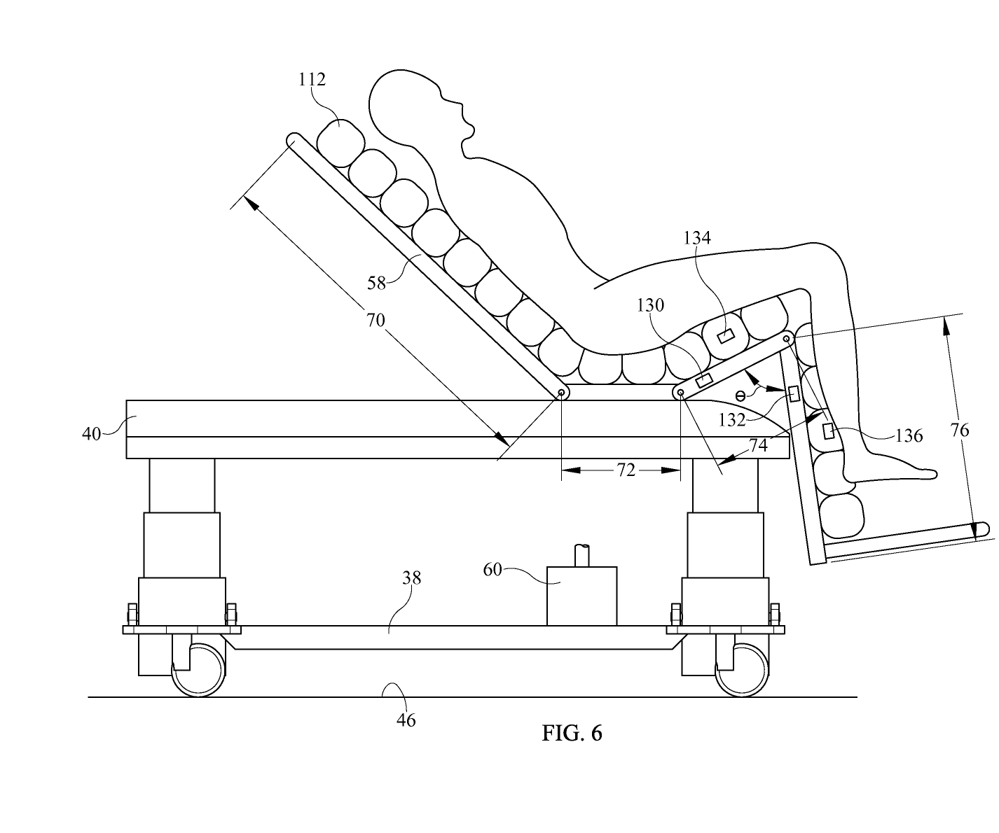

Referring additionally to FIG. 3, the bed also includes a support structure actuation system 100. As seen in FIG. 2 the actuation system comprises a torso segment actuator 102 extending between the elevatable frame 40 and the torso deck segment 70, a thigh segment actuator 104 extending between the elevatable frame and the thigh deck segment 74, and a calf segment actuator 106 extending between the elevatable frame and the calf deck segment 76. Examples of suitable actuators include motors, hydraulic cylinders and pneumatic cylinders. Operation of the deck segment actuators varies the angular orientations of the deck segments relative to the elevatable frame. As a result, at least a portion of support structure 56, specifically the deck component in the embodiment of FIG. 1, has a longitudinally variable profile or contour. FIG. 1 shows all the adjustable deck segments at a 0° orientation, thereby defining a flat profile. FIG. 2 shows a profile in which the thigh and calf segments are at a nonzero orientation as a result of the actuation system having varied the angular orientation of those segments. FIG. 5, which illustrates an embodiment different than that of FIGS. 1-2, shows a profile in which the torso and thigh segments are at a nonzero orientation as a result of the actuation system having varied the angular orientation of those segments. FIG. 6, shows the embodiment of FIG. 5 with a profile in which the torso, thigh and calf segments are at a nonzero orientation as a result of the actuation system having varied the angular orientation of those segments.

The lift system may be operated to change the elevation of the elevatable frame relative to the base frame without changing the profile. For example canister lifts 50, 52 may be operated in unison to raise or lower the elevatable frame, and therefore the deck, without affecting the flat profile of FIG. 1 or the non-flat profile of FIG. 2. The canister lifts may also be operated differentially (at different speeds and/or in opposite directions) to place the elevatable frame in an inclined orientation relative to the base frame without affecting the deck profile.

In practice, a mattress 110 is placed on the deck to support an occupant. The illustrated mattress is an air mattress 112 comprising a longitudinally distributed array of individual bladders 114, each of which extends laterally across the bed. Alternatively a different type of mattress, such as a foam mattress, could be employed. The mattress includes a torso or upper body section 120, a seat section 122, a thigh section 124 and a calf section 126, each corresponding approximately to an occupant'torso, buttocks, thighs and calves and to the torso, buttocks, thigh and calf deck segments. The mattress is affixed to the deck in any suitable manner such that the angular orientations α_{M}, β_{M}, δ_{M} of the various mattress sections remain equal to or approximately equal to the angular orientations α_{D}, β_{D}, δ_{D} of the corresponding deck segments. As a result, the profile of the mattress is a longitudinally variable profile that mimics the profile of the deck.

Various aspects of the profile may be employed to characterize it. For example one or more of the deck segment orientation angles α_{D}, β_{D}, δ_{D} or one or more of the mattress section orientation angles α_{M}, β_{M}, δ_{M} may be used to characterize the profile. Alternatively or additionally, feedback signals such as linear or angular displacement readings from actuators 102, 104, 106 may be used to characterize aspects of the profile. In the illustrated bed, angular orientation sensors 130, 132, are affixed to the thigh deck segment, the calf deck segment or both. Each sensor is responsive to the angular orientation of the deck segment to which it is affixed. The sensors acquire at least some of the information necessary to characterize one or more selected aspects of the variable profile. Additionally or alternatively, angular orientation sensors 134, 136, are affixed to the thigh mattress section, the calf mattress section or both. At least some of the acquired information could have an origin external to the occupant support. For example, as shown in FIG. 1, an angular orientation sensor 140, 142 could be strapped to the occupant's thigh and/or calf. Those skilled in the art will appreciate that the acquired information is information representative of whichever aspect or aspects of the profile are desired to be known. For example the representative information may be electrical signals whose magnitude is correlatable to an angular orientation or a linear or angular displacement rather than the actual orientation and displacement. Those skilled in the art will also realize that references to the actual parameter values (e.g. angles) are frequently understood to mean or to include the information representative of the actual parameter values (e.g. voltages). Factors such the kinematic particulars of a given bed, the desire to validate sensor output, and designer discretion will influence the selection of which aspects of the profile to measure or monitor.

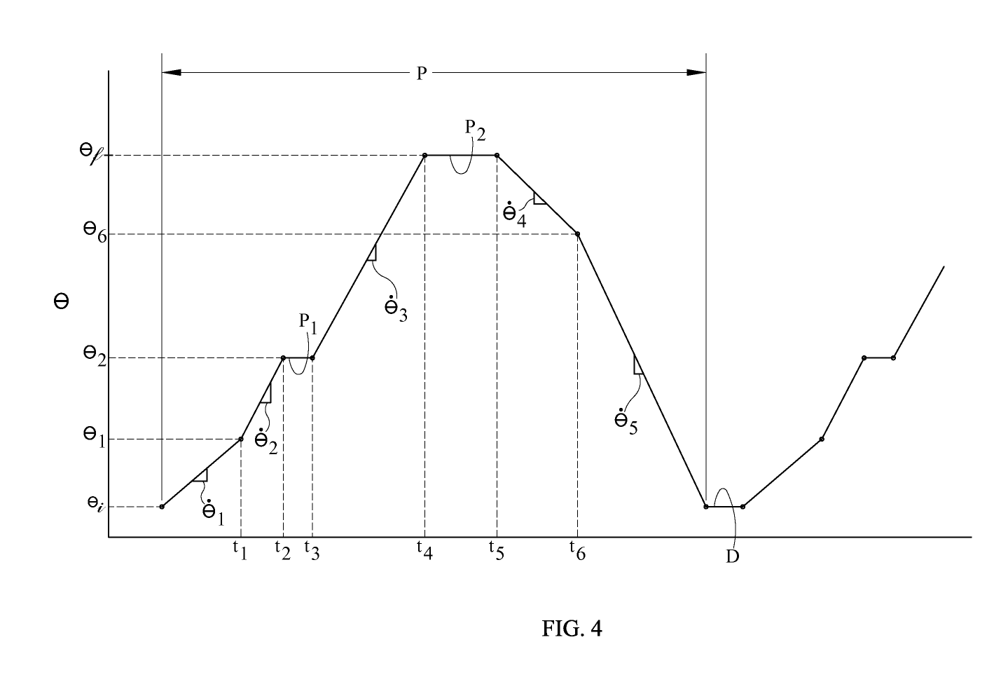

The illustrated bed also includes a controller 150 and a user interface 152 enabling the user to issue commands or specifications to the controller and to which the controller will respond. In particular the user interface allows the user to prescribe profile cycle parameters to define properties of a profile variation cycle, for example a cycle that begins with the profile of FIG. 1, attains the profile of FIG. 2 and then returns to the profile of FIG. 1. Referring additionally to FIG. 4, and using intersegment angle θ as an example, the user provided cyclic parameters can include the initial value of θ (θ₁), the final value of θ (θ_{f}), increasing and decreasing rates of change of θ (θdotₙ) intracycle pause intervals Pₙ, break point times tₙ or angles θₙ, cycle period P (or frequency), and intercycle delay interval D. The cyclic parameters may also include the quantity of cycles to be performed in a given therapy session, the quantity of sessions to be performed (where a session is one or more cycles) and the duration of intersession rest intervals.

FIG. 4 is intended to illustrate a wide variety of cycle parameters. An actual cycle is likely to be less complex. The controller is capable of commanding multiple cycles, but is also capable of commanding a single cycle if a caregiver selects only a single cycle.

In operation, a user uses user interface 152 to prescribe the cycle parameters. The controller responds to the user prescription by commanding the actuation system to effect the specified cyclic variation in the variable profile. In practical embodiments the controller also receives feedback 160, 162, i.e. the previously described information representative of an aspect of the variable profile, and responds to the feedback to correctly perform the requested cyclic variation of the variable profile. The controller may respond to the received information without further processing of the information or may process the information and respond to the results of the processing. In the example of FIGS. 1-2, the processor commands actuators 104, 106 to change deck angles β and δ from their prescribed initial values βᵢ and δᵢ of zero to prescribed nonzero final values β_{f} and δ_{f} and then back to zero. As noted above the commands issued by the controller will also conform to any other cyclic parameters prescribed by the user and will use feedback from whichever sensors are provided (e.g. pair 130, 132, pair 134, 136 or pair 140, 142) to regulate the cyclic variation.

In the embodiment of FIGS. 1-2 deck 58 is in a first position in which it is approximately longitudinally coextensive with elevatable frame 40 and is not longitudinally translatable relative to the elevatable frame. As a result, the achievable value of at least some of the orientation angles and/or of inter-segment angle θ, may be limited to values insufficient to provide fully effective therapy. For example the intersegment angle θ of the nontranslatable embodiment of FIGS. 1-2 is limited to a range whose maximum is about 180° (FIG. 1) and whose minimum is about 125° (FIG. 2). As seen in FIGS. 5-6, additional angular range may be obtained by employing a longitudinally translatable deck. FIG. 5 shows deck 58 having been translated footwardly, relative to its position in FIG. 1, to a second position in which a substantial portion of the deck extends footwardly beyond the elevatable frame 40. As seen in FIG. 6, the minimum achievable intersegment angle θ is about 70°, which is considerably less than the minimum intersegment angle of 125° achievable with the deck in its first longitudinal position.

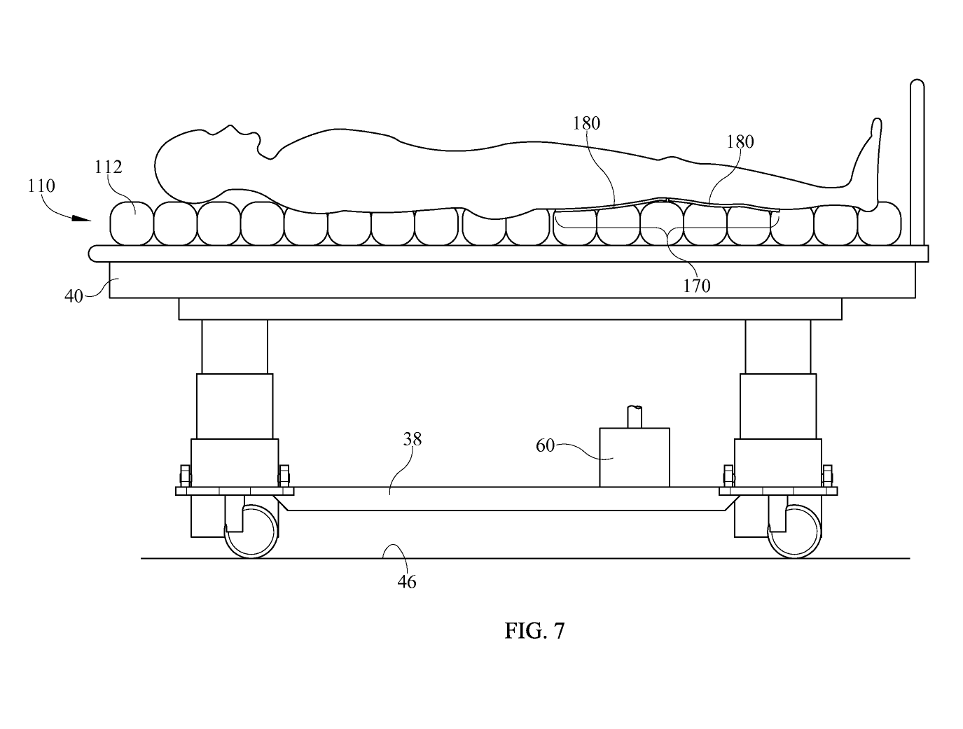

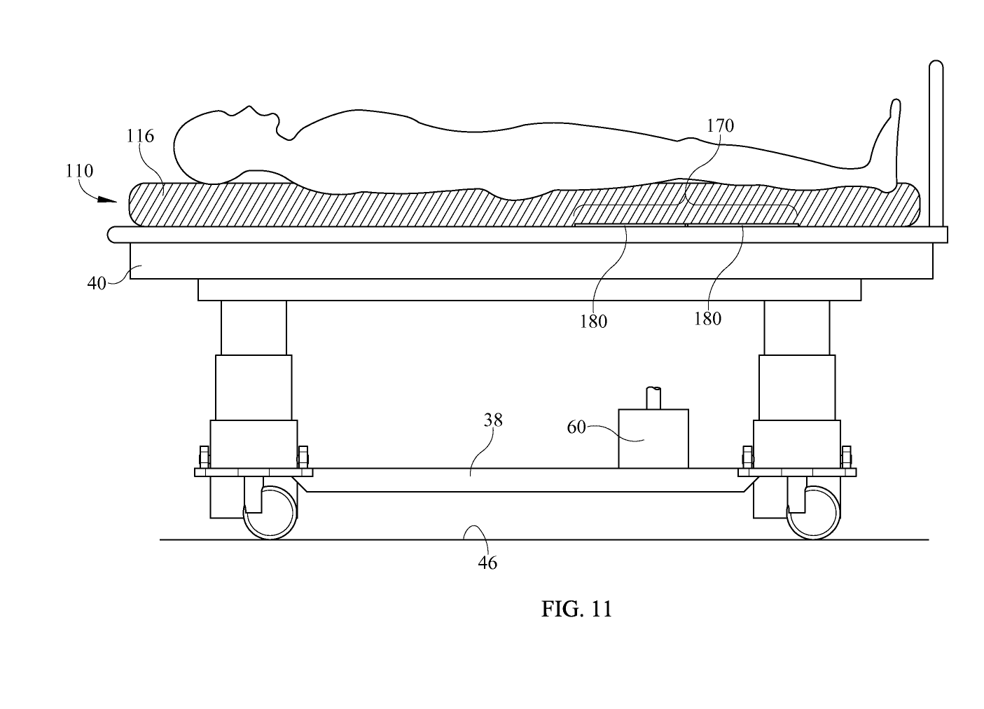

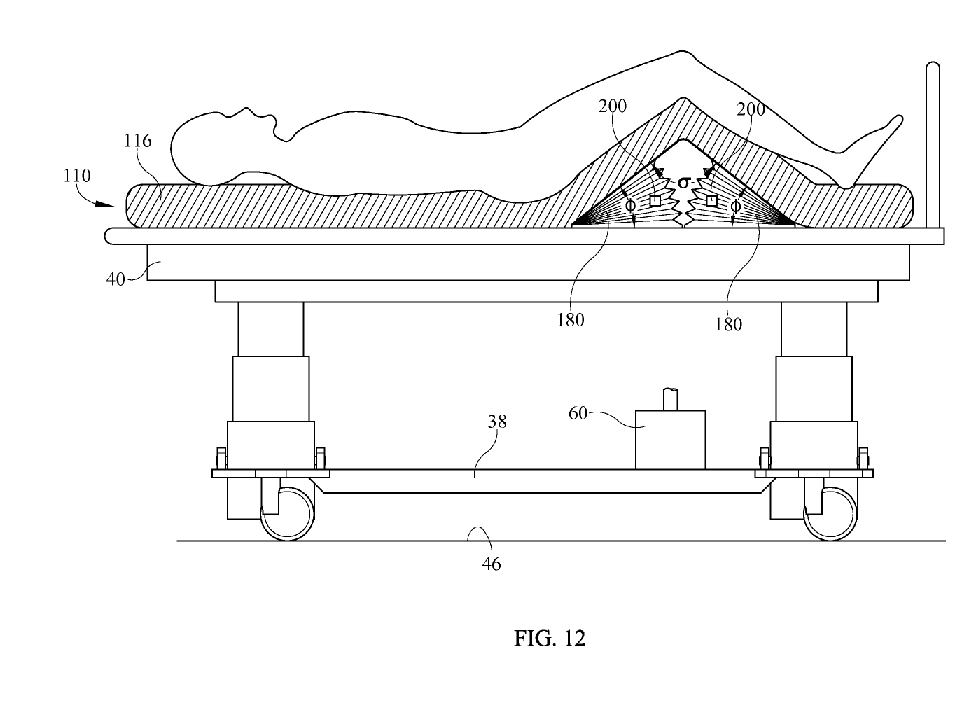

FIGS. 7-12 illustrate three embodiments in which support structure 56 comprises mattress 110 which is shown as either a base air mattress 112 (FIGS. 7-10) or foam mattress 116 (FIGS. 11-12) in combination with an orientation adjustment effector 170. The orientation adjustment effector 170 is a pressurizable component whose internal volume changes as a function of pressure. An actuation system for varying the variable profile of the support structure includes pump 60, which serves as an source of pressurized air to be supplied to the pressurizable component.

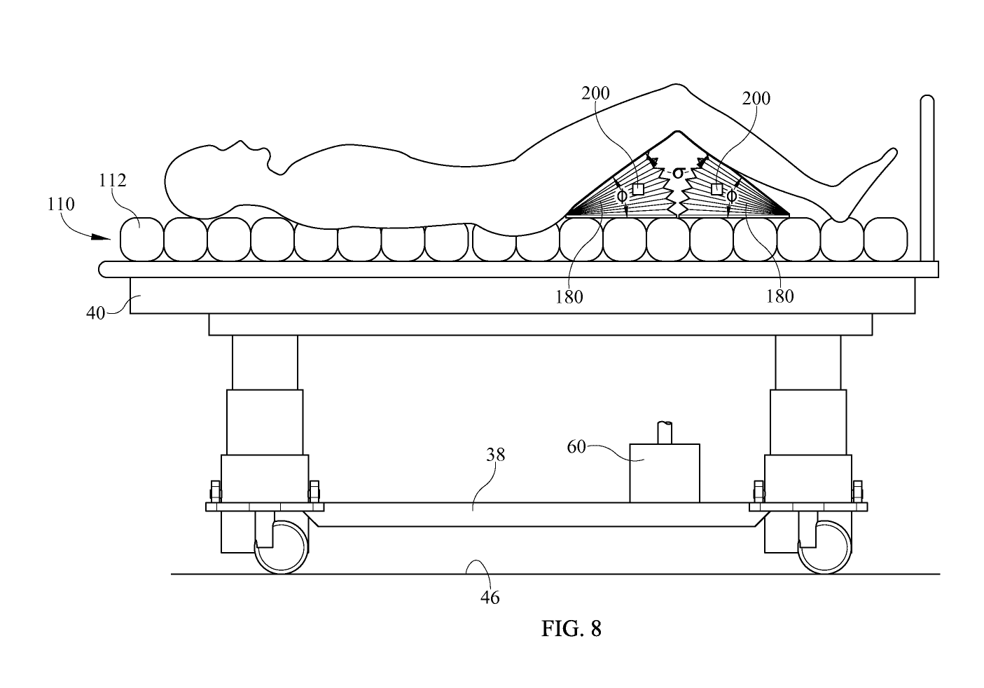

In FIGS. 7-8 the base mattress is an air mattress 112 similar to that of FIG. 1, and the pressurizable component is a pair of bellows 180 positioned above the base mattress. Pressure sensors 200 monitor bladder pressure to enable bellow spread angle φ to be estimated. FIG. 7 shows the bellows in a deflated or collapsed state in which the occupant's legs are in a neutral position. FIG. 8 shows the bellows in an inflated or expanded state as a result of pressurized air from pump 60 having been introduced into the bellows. Inflation of the bellows, causes the occupant's legs to be flexed by an amount σ related to bellows spread angle φ.

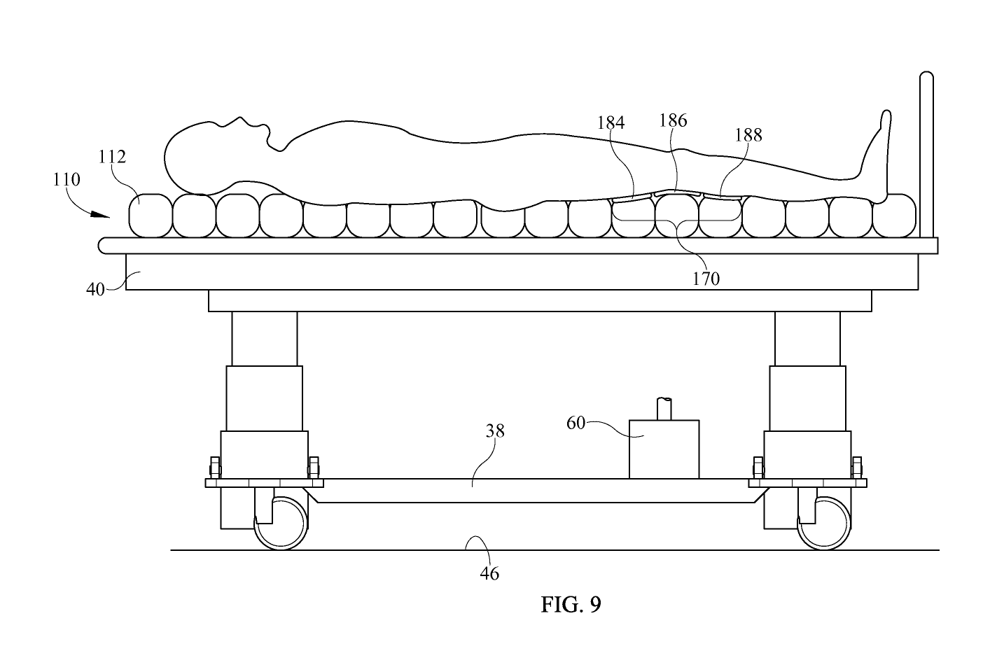

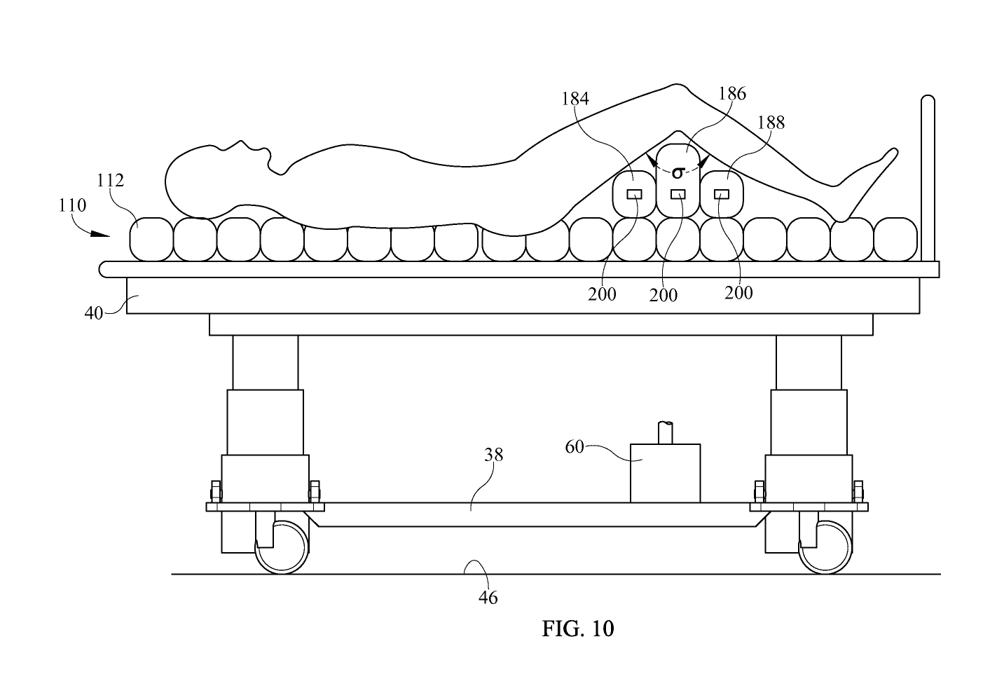

In FIGS. 9-10 the base mattress is an air mattress 112 similar to that of FIG. 1, and the pressurizable component 170 is a triplet of laterally extending orientation adjustment non-bellows bladders 184, 186, 188 positioned above the base mattress. Pressure sensors 200 monitor bladder pressure to enable knee joint flex angle σ to be estimated. FIG. 9 shows the bladders in a deflated or collapsed state in which the occupant's legs are in a neutral position. FIG. 10 shows the bladders in an inflated or expanded state as a result of pressurized air from pump 60 having been introduced into the bladders. The bladders of the illustrated embodiment are constructed and/or pressurized so that longitudinally interior bladder 186 expands to a height greater than that of longitudinally exterior bladders 184, 188. Inflation of the orientation adjustment bladders causes the occupant's legs to be flexed by an angle σ related to the heights of the bladders relative to the base mattress.

In FIGS. 11-12 the base mattress is a foam mattress 116, and the pressurizable component is a pair of bellows 180 positioned below the base mattress. FIG. 11 shows the bellows in a deflated or collapsed state in which the occupant's legs are in a neutral position. FIG. 12 shows the bellows in an inflated or expanded state as a result of pressurized air from pump 60 having been introduced into the bellows. Inflation of the bellows causes the occupant's legs to be flexed by an amount a related to bellows spread angle φ to be estimated. As with the embodiments of FIGS. 7-8, pressure sensors 200 enable the magnitude of spread angle to be estimated. Although the bellows of FIGS. 11-12 is a component of the mattress it could instead be a component of deck 58.

Continuing to refer to FIGS. 7-12, the foam base mattress could be substituted for the base air mattress and vice versa. The pressurizable component (e.g. bellows and triplet of orientation adjustment bladders) could be placed above or below the base mattress. Moreover a segmented deck could be substituted for the non-segmented deck of FIGS. 7-12. As already noted, to the extent that pressure inside the pressurizable component can satisfactorily characterize the profile of the bed, pressure sensor 200 which is responsive to pressure in the pressurizable component could be used instead of an angular orientation sensor. A pressure sensor could also be used in addition to an angular orientation sensor, for example to provide a benchmark for parameter validation and/or to serve as a backup sensor to accommodate failure of a primary sensor.

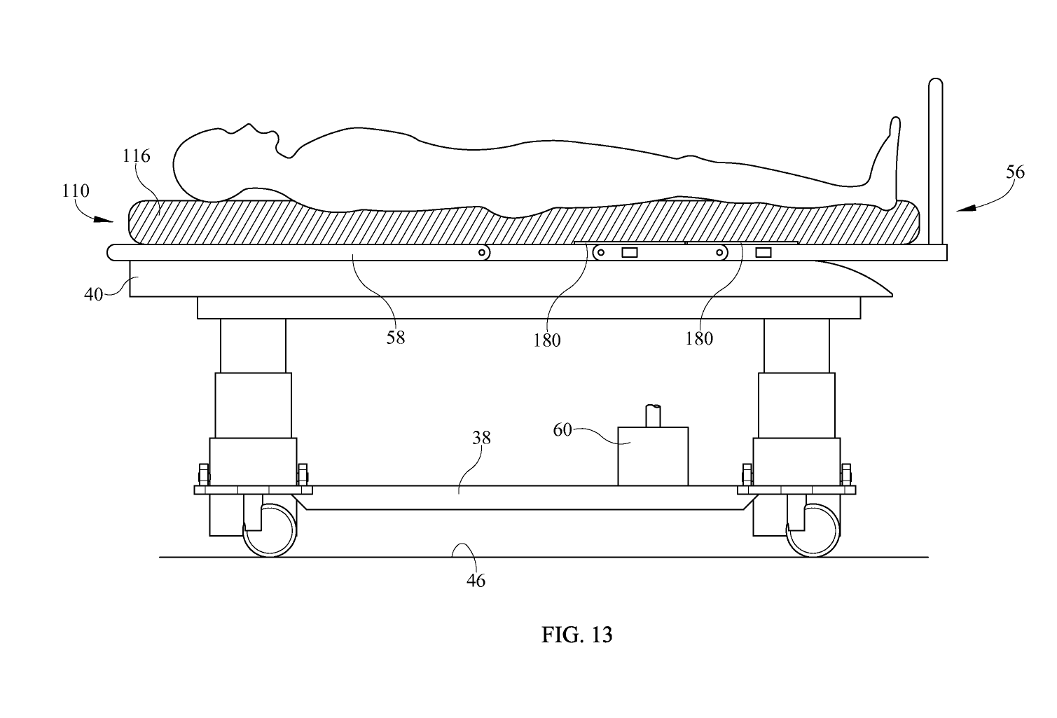

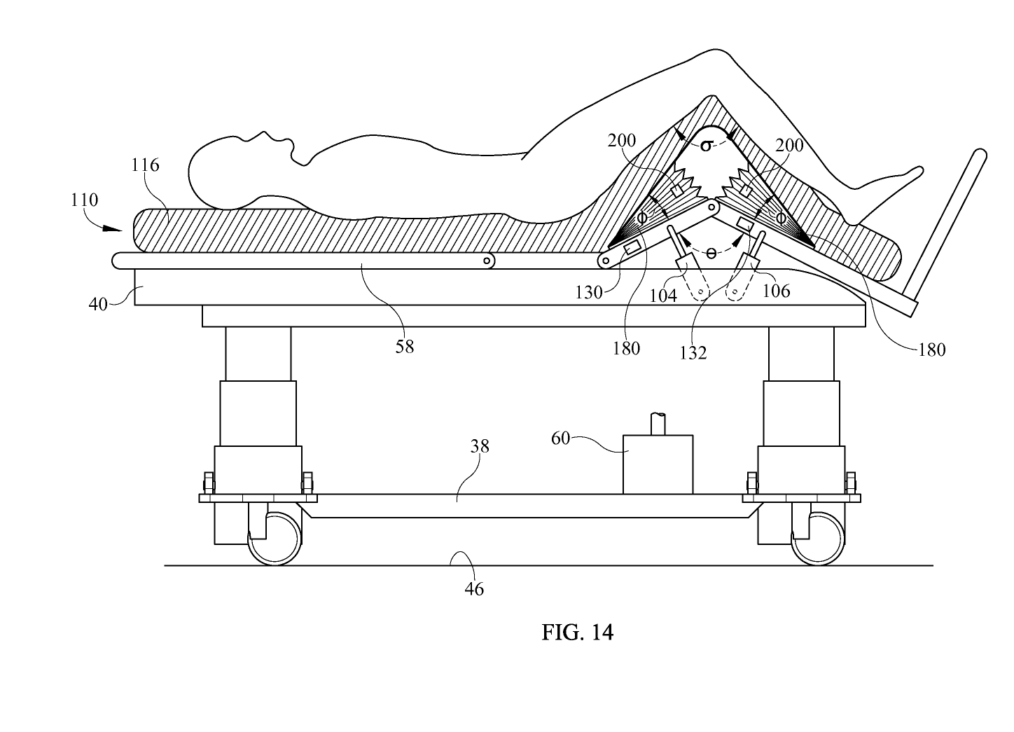

The embodiments specifically illustrated in FIGS. 1-2 and 5-6 are “frame based” embodiments because frame components are used to effect the variation in profile. The embodiments specifically illustrated FIGS. 7-12 are “mattress based” embodiments because mattress components are used to effect the variation in profile. FIGS. 13-14 show a hybrid embodiment in which the occupant support comprises base frame 38, elevatable frame 40 and a support structure 56. The support structure includes segmented deck 58 and mattress 110. Mattress 110 includes a foam base mattress 116 and an orientation adjustment effector in the form of a pair of bellows 180 positioned below the base mattress. In FIG. 13 the deck segments are all oriented at approximately 0° relative to the elevatable frame, and the bellows is deflated. In FIG. 14 actuators 104, 106 have rotated thigh segment 74 and calf segment 76 to non-zero orientations, and pump/actuator 60 has inflated the bellows to a spread angle φ to achieve a knee flexure angle σ more acute than that which could be obtained with either the deck segments or the bellows alone.

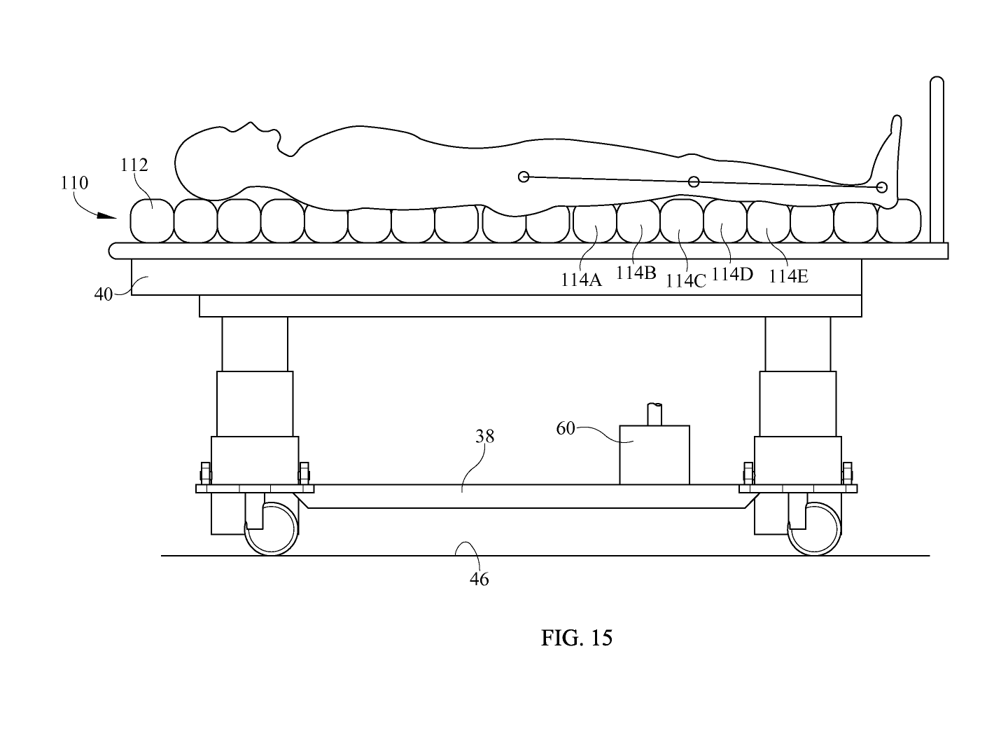

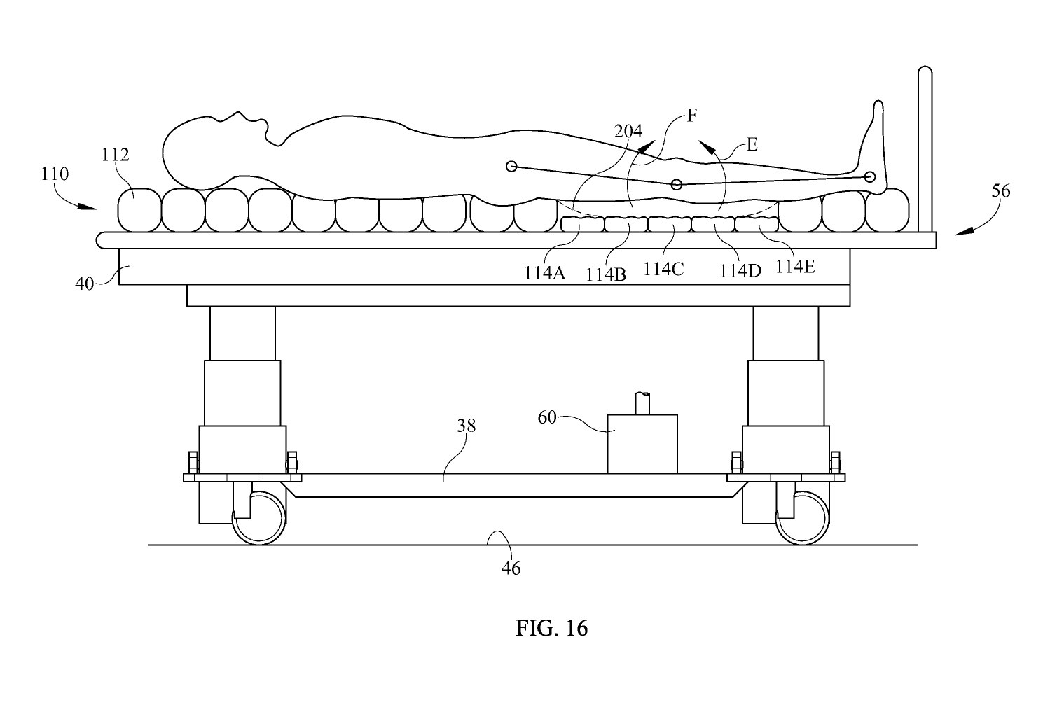

FIGS. 15-21 show embodiments including components operable to provide or withhold popliteal support for a supine occupant of the occupant support. In contrast to the embodiments of FIGS. 1-2 and 5-14 which flex the occupant's knee, the embodiments of FIGS. 15-21 withdraw popliteal support to place the occupant's knee joint in a condition of extension. That is, the occupant's calf and thigh tend to rotate in directions E and F (FIG. 16), which is opposite the normal flex direction shown in the previous illustrations.

Referring to FIGS. 15-16 the occupant support includes base frame 38, an elevatable frame 40, an actuator system including pump 60, and a support structure 56. The support structure includes a mattress 110, at least a portion of which is operable to provide or withhold popliteal support for a supine occupant of the bed. In particular, mattress 110 is an air mattress 112 comprising multiple individual bladders 114, five of which (114A, 114B, 114C, 114D, 114E) are inflatable so that they cooperate with the other bladders, as seen in FIG. 15, to define a substantially continuous and approximately planar profile corresponding to a flat profile that provides popliteal support. As seen in FIG. 16 the five popliteal bladders are also deflatable to define an effective concavity 204 or discontinuity corresponding to a non-flat profile. As seen by comparing FIG. 15 to FIG. 16, deflation of the popliteal bladders allows the occupant's calf and thigh to rotate slightly in directions E and F. Factors such as the actual longitudinal position of the occupant relative to the poplitial bladders and the amount of bending moment desired to be applied to the occupants knee joint will determine which of the popliteal bladders are selected for deflation.

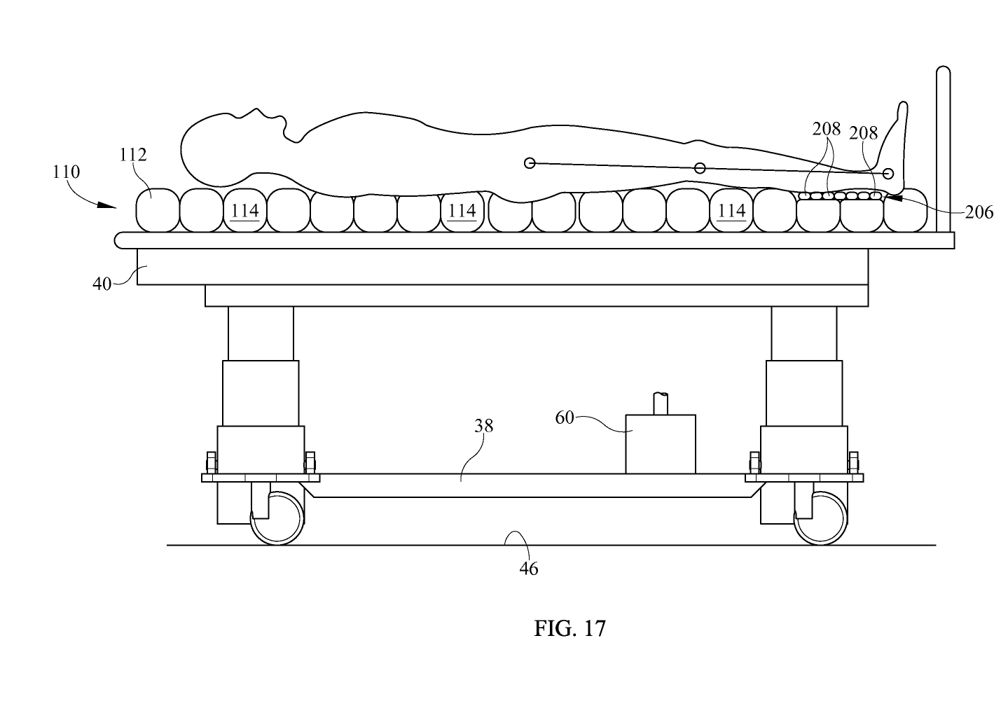

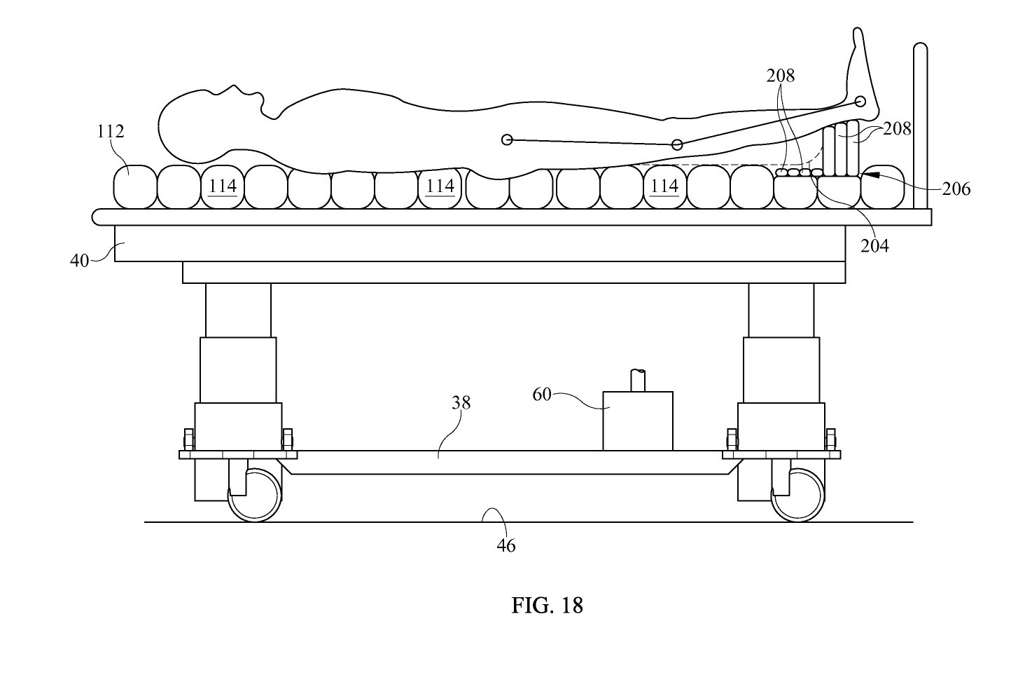

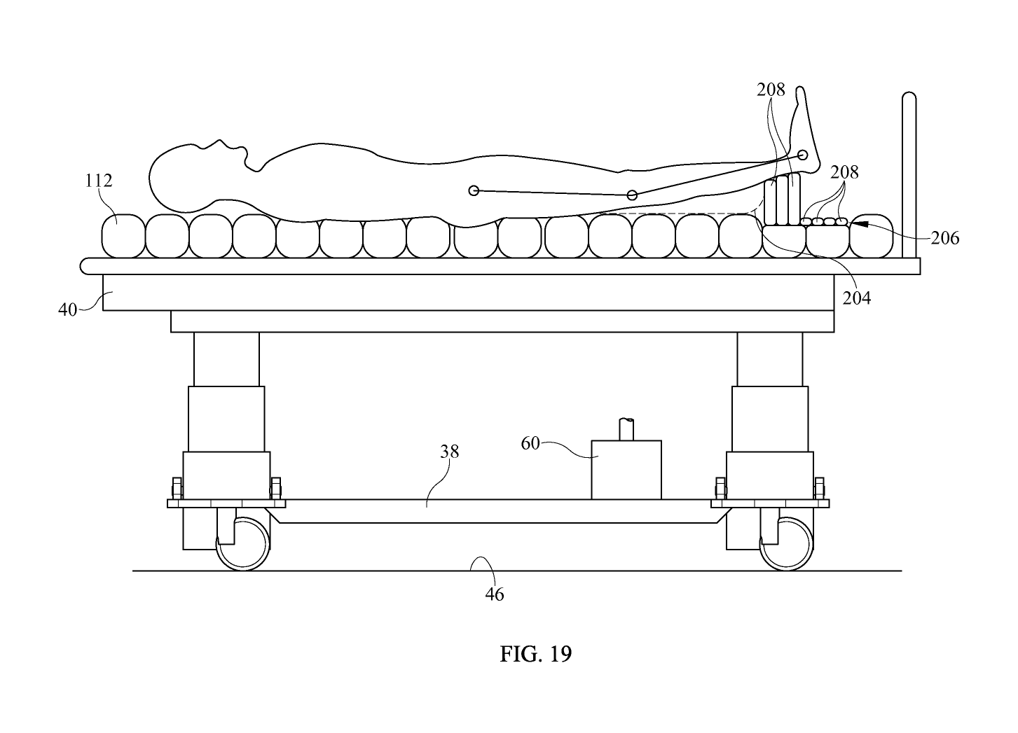

FIGS. 17-19 illustrate another embodiment in which the support structure includes a mattress 110, at least a portion of which is operable to define an effective concavity 204 corresponding to a non-flat profile. The mattress includes a primary support in the form of a layer of primary support bladders 114. The mattress also includes an elevator in the form of longitudinally distributed, selectively inflatable elevation bladders 208 positioned above the primary support. An actuation system includes pump 60. As seen in FIG. 17 the elevator bladders are deflatable so that they cooperate with the primary support to define a substantially continuous and planar profile corresponding to a flat profile that provides popliteal support. In the deflated state the elevator bladders may be completely deflated so that the air pressure inside the bladders is negligible. In this state the deflated bladders cannot react any loads and therefore are dedicated to providing or withholding popliteal support. Alternatively, the elevator bladders may be deflated to a state in which they are still slightly pressurized so that they are load bearing even when deflated. In this state the slightly pressurized elevator bladders contribute to the load bearing capacity of the primary support. As seen in FIGS. 18-19 selected bladders are inflatable to define an effective concavity 204 or discontinuity corresponding to a non-flat profile. As seen by comparing FIG. 17 to FIGS. 18-19, inflation of the selected elevator bladders withdraws popliteal support and allows the occupant's calf and thigh to rotate slightly in directions E and F. Factors such as the longitudinal position of the occupant relative to the elevation bladders and the amount of bending moment desired to be applied to the occupant's knee joint will determine which of the elevation bladders are selected for inflation.

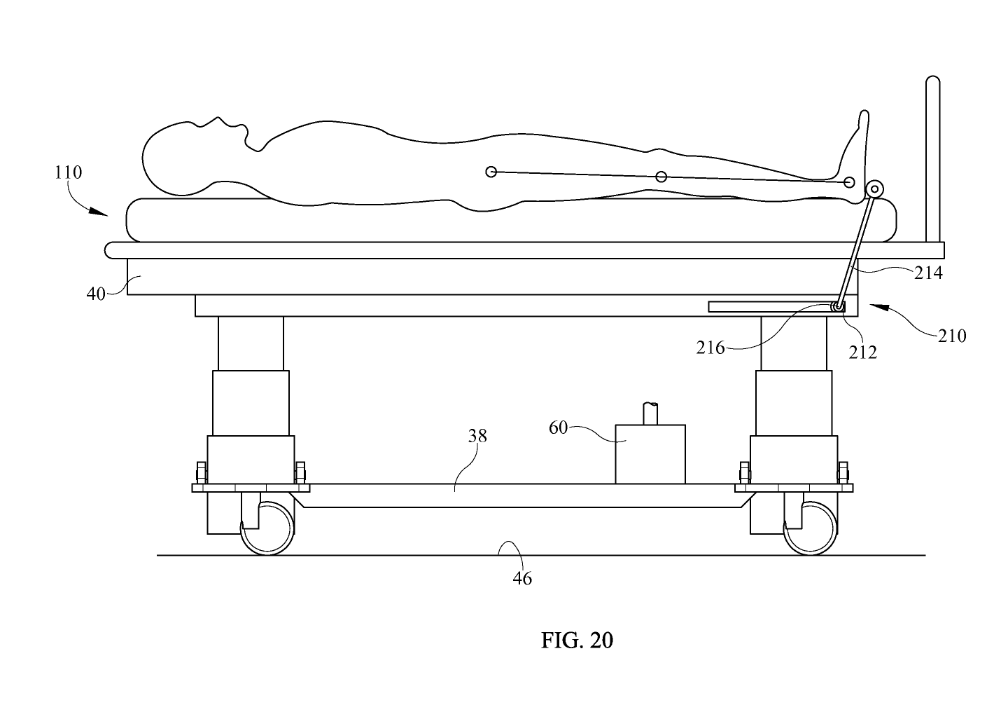

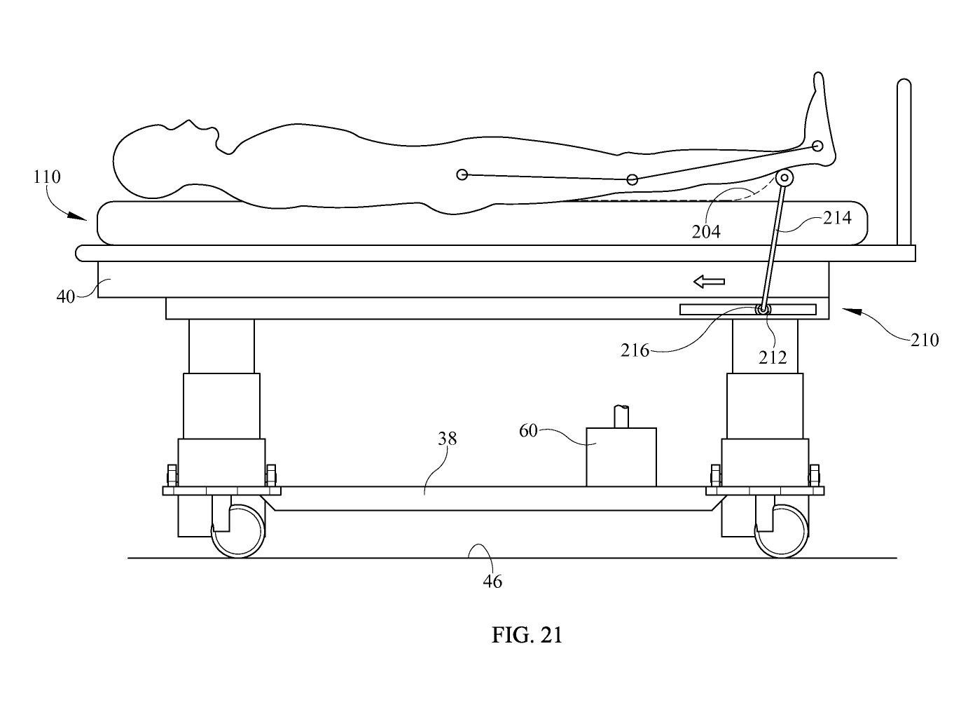

Referring to FIGS. 20-21, another embodiment of the occupant support includes a base frame 38, an elevatable frame 40 and a support structure comprising deck 58 or mattress 110, and a spacer assembly 210. The spacer assembly includes a base 212, a link 214 rotatable relative to the base about axis 216 and a roller 220 rotatably mounted on the opposite end of the link. The roller extends laterally from the right side of the bed to the left side where it may be connected to a second link similar to the one visible in the illustration. FIG. 20 shows the spacer in a neutral position in which it provides popliteal support by enabling mattress 110 to support the entire length of the occupant's leg. FIG. 21 is a view of the bed of FIG. 20 showing the spacer having been moved longitudinally so that roller 220 has rolled under the occupant's leg sufficiently far to withhold popliteal support from the occupant's knee. The spacer can also be adjusted vertically by rotating link 214 about axis 216. The actuation system for the spacer can include one or more actuators such as a linear actuator a ballscrew or a motor to translate the assembly longitudinally and rotate the link about its axis. The spacer and the mattress, which reflects the flat profile of the deck, cooperate to define concavity 204.

Although this disclosure refers to specific embodiments, it will be understood by those skilled in the art that various changes in form and detail may be made without departing from the subject matter set forth in the accompanying claims.

We claim:

1. An occupant support comprising:
a support structure at least one component of which has a variable profile;
an actuation system for varying the variable profile of the support structure; and
a controller responsive to prescribed profile cycle parameters for commanding the actuation system to effect a cyclic variation in the variable profile.

2. The occupant support of claim 1 wherein the variable profile is a longitudinally variable profile.

3. The occupant support of claim 1 wherein the controller receives information representative of an aspect of the variable profile and responds to the received information.

4. The occupant support of claim 3 comprising at least one sensor for acquiring at least a subset of the representative information.

5. The occupant support of claim 3 wherein at least some of the representative information has an origin external to the occupant support.

6. The occupant support of claim 1 wherein the support structure includes a deck having one or more segments each of which is positionable at various angular orientations to define a longitudinally variable profile.

7. The occupant support of claim 6 wherein the one or more deck segments includes a calf segment and a thigh segment, the occupant support including at least one sensor.

8. The occupant support of claim 7 wherein the at least one sensor is an angular orientation sensor responsive to angular orientation of the calf segment and/or the thigh segment, and the controller responds to the sensed angular orientation.

9. The occupant support of claim 6 wherein the deck is longitudinally translatable from a first position to a second position and the deck segments include a calf segment and a thigh segment, the longitudinally variable profile being defined at least in part by an angle formed by the calf and thigh segments, the angle having a first minimum value of less than 180 degrees at the first position and a second minimum value at the second position, the second minimum value being less than the first minimum value.

10. The occupant support of claim 9 wherein the second minimum value is about 70 degrees.

11. The occupant support of claim 1 wherein the support structure includes a mattress having one or more sections each of which is positionable at various angular orientations to define a longitudinally variable profile.

12. The occupant support of claim 11 wherein the one or more mattress sections include a calf section and a thigh section, the occupant support comprising at least one sensor.

13. The occupant support of claim 12 wherein the at least one sensor is an angular orientation sensor responsive to angular orientation of the calf section and/or the thigh section, and the controller responds to the sensed angular orientation.

14. The occupant support of claim 11 comprising a base mattress and one or more orientation adjustment effectors above or below the base mattress for effecting the cyclic variation in the longitudinally varying profile.

15. The occupant support of claim 14 wherein the orientation adjustment effector is a pressurizable component.

16. The occupant support of claim 15 wherein the pressurizable component is a bellows.

17. The occupant support of claim 15 wherein the pressurizable component is one or more non-bellows bladder.

18. The occupant support of claim 15 including a pressure sensor responsive to pressure in the pressurizable component.

19. The occupant support of claim 1 including components operable to provide or withhold popliteal support for a supine occupant of the occupant support.

20. The occupant support of claim 1 wherein the support structure includes a mattress, a portion of which is operable to provide or withhold popliteal support for a supine occupant of the occupant support.

21. The occupant support of claim 1 wherein the support structure includes a mattress, at least a portion of which comprises one or more bladders which are operable to produce an effective concavity.

22. The occupant support of claim 21 wherein the mattress portion comprises a primary support and an elevator.

23. The occupant support of claim 22 wherein the elevator comprises longitudinally distributed, selectively inflatable bladders.

24. The occupant support of claim 23 wherein the longitudinally distributed, selectively inflatable bladders are dedicated to providing or withholding popliteal support.

25. The occupant support of claim 1 wherein the support structure includes a spacer operable to provide or withhold popliteal support for a supine occupant of the occupant support.

26. The occupant support of claim 25 wherein the spacer is longitudinally and/or vertically adjustable.

27. The occupant support of claim 1 wherein the variable profile includes an angle and the cyclic variation involves a change in the angle over time.

28. The occupant support of claim 27 wherein the user input includes at least one of a magnitude of an angle, a rate of change of an angle, intracycle pause intervals, break point specification, cycle period, intercycle delay interval, quantity of cycles, intersession rest interval, and quantity of sessions.

29. A mattress comprising multiple individual bladders, some of which are cyclically inflatable and deflatable and, when inflated, cooperate with the other inflatable bladders to define a profile that provides popliteal support for a supine occupant thereof, and, when deflated, cooperate with the other inflatable bladders define an effective concavity corresponding to a profile that withholds popliteal support from the occupant.

30. A mattress comprising:
a primary support;
an elevator above the primary support, the elevator having a deflated state in which it cooperates with the primary support to provide popliteal support to a supine occupant of the mattress, the elevator also having an inflated state in which it withholds popliteal support from the supine occupant.

31. The mattress of claim 30 wherein in the inflated state the elevator cooperates with the primary support to define an effective concavity that withholds the popliteal support.

32. The mattress of claim 30 wherein the elevator comprises at least one selectively inflatable and deflatable elevation bladder

33. The mattress of claim 30 wherein the elevator, when in its deflated state, is load bearing.
